(19) United States
(12) Patent Application Publication
(10) Pub. No.: US 2025/0289923 A1
(43) Pub. Date: Sep. 18, 2025

(54) POLYESTER COVALENTLY ADAPTABLE NETWORKS WITH AMINES FOR ENHANCED RECYCLABILITY AND CURE

(71) Applicant: Alliance for Sustainable Energy, LLC, Golden, CO (US)

(72) Inventors: Nicholas A. RORRER, Golden, CO (US); Erik Glenn ROGNERUD, Parker, CO (US); Robynne E. MURRAY, Superior, CO (US); Ryan William CLARKE, Wheat Ridge, CO (US)

(21) Appl. No.: 19/083,087

(22) Filed: Mar. 18, 2025

Related U.S. Application Data
(60) Provisional application No. 63/566,734, filed on Mar. 18, 2024.

(51) Int. Cl. C08G 59/42; C08G 59/32; C08G 59/68; C08J 11/24

(52) U.S. Cl. CPC C08G 59/4238; C08G 59/32; C08G 59/686; C08J 11/24; C08J 2363/00

(57) ABSTRACT

Disclosed herein are methods for transesterification of polyester containing polymers, that can rearrange to allow reprocessing and with methanol to allow depolymerization. All of which are also catalyzed and/or accelerated by a nitrogen-based unit.

### CROSS-REFERENCE TO RELATED APPLICATIONS

This application claims priority under 35 U.S.C. § 119 to U.S. provisional patent application No. 63/566,734 filed on 18 Mar. 2024, the contents of which are hereby incorporated in their entirety.

### CONTRACTUAL ORIGIN

The United States Government has rights in this invention under Contract No. DE-AC36-08GO28308 between the United States Department of Energy and Alliance for Sustainable Energy, LLC, the Manager and Operator of the National Renewable Energy Laboratory.

### BACKGROUND

There is a need for improving recycling of polyesters. Reducing the amount of plastic waste is important to the environment. Increasing the recyclability of plastics containing polyester bonds would greatly reduce the amount of plastic waste. The monomer components and the decomposition products from recycled plastic could be valorized to create compounds of interest.

### SUMMARY

In an aspect, disclosed herein are methods for advancing circularity into thermosetting resin systems comprising the use of a multi-epoxide (di-epoxide or greater) monomer unit with internal hydroxy functionality (conventionally sorbitol polyglycidyl ether—SPGE). In an embodiment, the method of claim 1 further comprises the use of an anhydride hardener (conventionally methyl hexahydropthalic anhydride—MHHPA) and the step of combining with epoxy and nitrogen-based accelerator (conventionally 2-ethyl-4-methyl imidazole—24EMI) to facility the cure (called crosslinking, polymerization, gelation, reaction, etc) into a rigid 3-dimensional network. In an embodiment, the network can rearrange with itself to allow re-processing and with methanol to allow depolymerization. In an embodiment, the reactions are catalyzed and/or accelerated by a nitrogen-based unit. In an embodiment, the reactions constitute the cure (or polymerization) as well as the network rearranging with itself (internal transesterification) and the rearrangement with methanol to allow depolymerization (methanolysis).

In an embodiment, the method uses different nitrogen-based accelerators at different loadings to accelerate both cure and transesterification.

Other objects, advantages, and novel features of the present invention will become apparent from the following detailed description of the invention when considered in conjunction with the accompanying drawings.

### BRIEF DESCRIPTION OF THE DRAWINGS

FIG. 1 depicts the state of the industry (top) and the methods disclosed herein (bottom) to advance circularity into thermosetting (traditionally non-recyclable) resin systems.

FIG. 2 depicts representative structures and example monomers for each class of materials disclosed herein. Accelerators, or alternatively referred to herein as catalysts, as depicted in FIG. 2 include, but are not limited to, N-methyl piperidine (Mpip); triethylamine (TEA); imidazole (Imid): 1-methyl imidazole (1 MI): pyridine (Pyr): dimethyl aniline (DMAn): tributylamine (TBA): tripropylamine (TPA): 2-ethyl-4-methyl imidazole (24EMI): 1,8-diazabicyclo[5.4.0]undec-7-ene (DBU): 4-dimethylaminopyridine (DMAP): and N,N,N,N-tetramethyl-1,4-phenylenediamine (TMPDA).

FIG. 3 depicts a representative PolyEster Covalent Adaptable Network (PECAN) thermoset network disclosed herein. In an embodimenet, a composition of 0.3 mol equivalents of SPGE, 0.7 mol equivalents of butanediol diglycidyl ether (BDODGE), and 1.0 mol equivalents of MHHPA is used.

FIG. 4 depicts isothermal heat flow experiments of PECAN formulations with different nitrogen-based-catalyst. The heat flow of the resin sample is measured via differential scanning calorimetry (DSC) to evaluate the exotherm (signal in the positive direction) of the reaction. FIG. 4 depicts an isothermal dwell of 80° C. for 500 minutes showing the effect of increasing nitrogen catalyst loading will influence the cure response.

FIGS. 5A, 5B, and 5C depict the effect of catalyst on the curing procedure. FIG. 5(A) depicts an overlay of DSC thermogram dynamic cures (heated from 25° C. to 200° C. at 2° C./min) analyze the heat of the reaction as a function of temperature for a variety of different nitrogen-based catalysts (0.02 mol equivalent). The thermograms are color coded to catalysts (accelerators) depicted in FIG. 2. The differences in the shapes of the exotherm show how the heat of the reaction and therefore the polymerization can be tuned with the choice in nitrogen-based catalyst. FIB. 5B depicts a graphical representation of the onset temperature, or temperature when the exotherm begins to aggressively ramp, from the dynamic curing experiments shown in (FIG. 5A). FIG. 5C depicts a graphical display of the cure progression for each PECAN system with different catalysts denoting the gel point and the cure completion at an industrially relevant temperature of 80° C. Gel point is noted as the time at which the liquid mixture become a solid quantified from rheological experiments (1% strain, 10 rad/s, 80° C.) as the point when the storage modulus and the loss modulus intersect. End set temperatures are noted as the time at which the exotherm (akin to experiments depicted in FIG. 5A) begins to rapidly decay denoted the nominal completion of the reaction.

FIG. 6 depicts a proposed mechanism for the nitrogen-mediated internal reaction within a PECAN thermoset.

FIGS. 7A and 7B depict (A) Stress relaxation experiments on a PECAN formulation at temperatures from 185° C. to 215° C. within a Dynamic Mechanical Analyzer (DMA).

FIG. 8 depicts percent deconstruction via methanolysis or transesterification with methanol for PECAN formulations cured with various catalysts as disclosed herein, see FIG. 2.

### DETAILED DESCRIPTION

The incorportation of amines into polyester thermoset compounds results in three benefits: (1) curing at reasonable temperatures (80-120° C.) and (2) enhanced internal transesterifacation (reaction with a backbone [intrinsic to the polymer chain] ester and a backbone alcohol (conventionally a hydroxyl) and (3) enhanced external transesterification (reaction with a backbone ester and an external alcohol (conventionally methanol). As the lack of latent cure may hinder the ability for the PECAN resin to be implemented in large composite applications this technology overcomes that issue while affording an additional benefit. Applicants have unexpectedly discovered that increasing the nitrogen content (both in concentration and composition or structure) in our formulations of polyester compounds further increases the recyclability of polyester containing plastics.

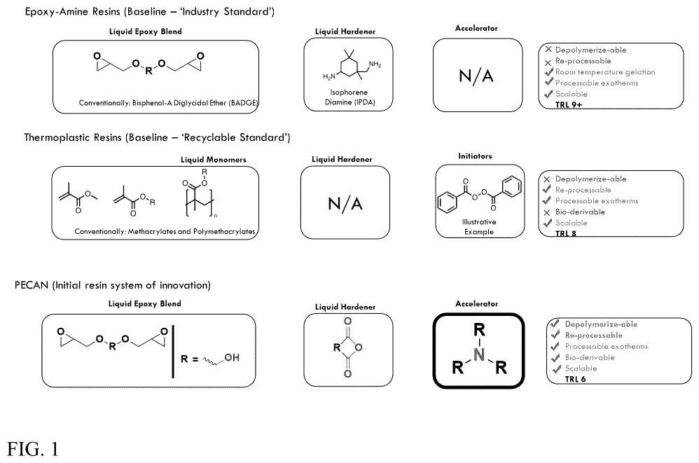

FIG. 1 depicts the state of the industry (top) and the research/innovation we have done (bottom) to advance circularity into thermosetting (traditionally non-recyclable) resin systems. This work initially utilized a multi-epoxide (di-epoxide or greater pictured) monomer unit with internal hydroxy functionality (conventionally sorbitol polyglycidyl ether—SPGE). An anhydride hardener (conventionally methyl hexahydropthalic anhydride—MHHPA) is combined with epoxy and nitrogen-based accelerator (conventionally 2-ethyl-4-methyl imidazole—24EMI) to facilitate the cure (called crosslinking, polymerization, gelation, reaction, etc) into a rigid 3-dimensional network. Through transesterification, this network can rearrange with itself to allow re-processing and with methanol to allow depolymerization. All of which are also catalyzed and/or accelerated by the nitrogen-based unit, both in concentration and composition or structure. The use of different nitrogen-based accelerators at different concentrations for this system to accelerate both cure and transesterification are to be captured. Additionally, a new resin system utilizes multifunctional (di-functional is pictured) epoxies connected to ester groups that can mix and cure with a multifunctional amine (di-functional is

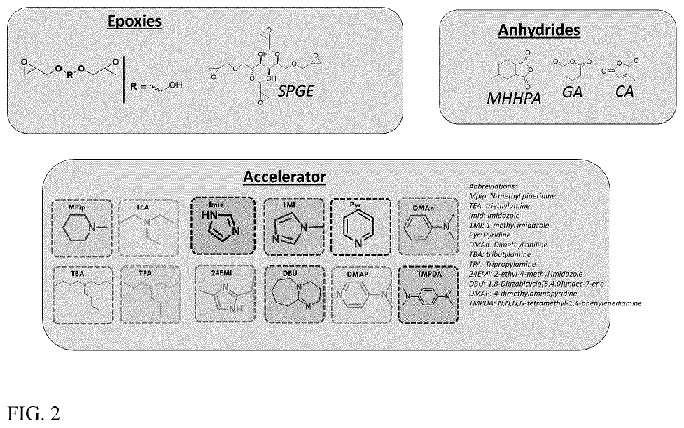

FIG. 2 depicts representative structures and example monomers are given above for each class of materials. Monomers are combined in any addition order and in varying stoichiometry (anhydride to epoxide). Monomers (generally liquid but can be solid) are mechanically mixed with and/or without solvent to generate a homogenous mixture of monomers. The mixture can then be cast into desired shape or into desired reinforcing media (carbon fiber, glass fiber, basalt fiber, Kevlar, flax fibers, bio-fibers, fillers, etc.) where they will cure (or gel, or polymerize, or solidify) under a stimulus of time, temperature, infrared laser, or UV-light. The final solid product is then deployed or evaluated for performance. In an embodiment, methylhexahydrophthalic anhydride (MHHPA) is obtained from a Diels-Alder condensation of isoprene and maleic anhydride (obtained by biological cultivation and by conversion of fructose respectively). In an embodiment, citraconic anhydride is obtained from dehydration and subsequent decarboxylation of citric acid.

Methods disclosed herein can be used on multiple polyesters, including mixed feedstocks. The polymer concentrations used are quite high, increasing efficiency, but the required catalyst loadings are low. The process is scalable and runs at reduced energy and solvent loadings compared to most existing methanolysis systems.

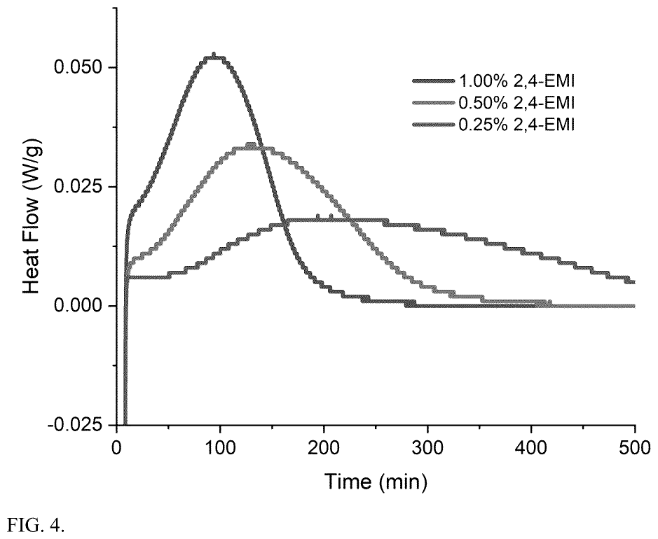

FIG. 4 depicts isothermal heat flow experiments of a PECAN formulation (specifically with 0.7 mol eq of SPGE, 0.3 mol equivalent of BDODGE, and 1.0 mol equivalent of MHHPA) with different nitrogen-based-catalyst. The heat flow of the resin sample is measured via differential scanning calorimetry (DSC) to evaluate the heat or exotherm (signal in the positive direction) of the reaction. This representative figure is an isothermal dwell of 80° C. for 500 minutes showing the effect of increasing nitrogen catalyst loading will influence the cure response.

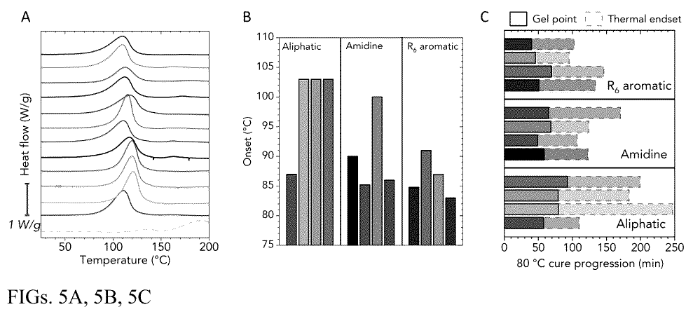

FIG. 5 depicts the effect of catalyst on the curing procedure. FIG. 5(A) depicts an overlay of DSC thermogram dynamic cures (heated from 25° C. to 200° C. at 2° C./min) analyze the heat of the reaction as a function of temperature for a variety of different nitrogen-based catalysts (0.02 mol equivalent). The thermograms are color coded to catalysts (accelerators) depicted in FIG. 2 and include, but are not limited to, N-methyl piperidine (Mpip); triethylamine (TEA); imidazole (Imid): 1-methyl imidazole (1 MI): pyridine (Pyr): dimethyl aniline (DMAn): tributylamine (TBA): tripropylamine (TPA): 2-ethyl-4-methyl imidazole (24EMI): 1,8-diazabicyclo[5.4.0]undec-7-ene (DBU): 4-dimethylaminopyridine (DMAP): and N,N,N,N-tetramethyl-1,4-phenylenediamine (TMPDA).

The differences in the shapes of the exotherm show how the heat of the reaction and therefore the polymerization can be tuned with the choice in nitrogen-based catalyst. FIB. 5B depicts a graphical representation of the onset temperature, or temperature when the exotherm begins to aggressively ramp, from the dynamic curing experiments shown in (FIG. 5A). FIG. 5C depicts a graphical display of the cure progression for each PECAN system with different catalysts denoting the gel point and the cure completion at an industrially relevant temperature of 80° C. Gel point is noted as the time at which the liquid mixture become a solid quantified from rheological experiments (1% strain, 10 rad/s, 80° C.) as the point when the storage modulus and the loss modulus intersect. End set temperatures are noted as the time at which the exotherm (akin to experiments depicted in FIG. 5A) begins to rapidly decay denoted the nominal completion of the reaction.

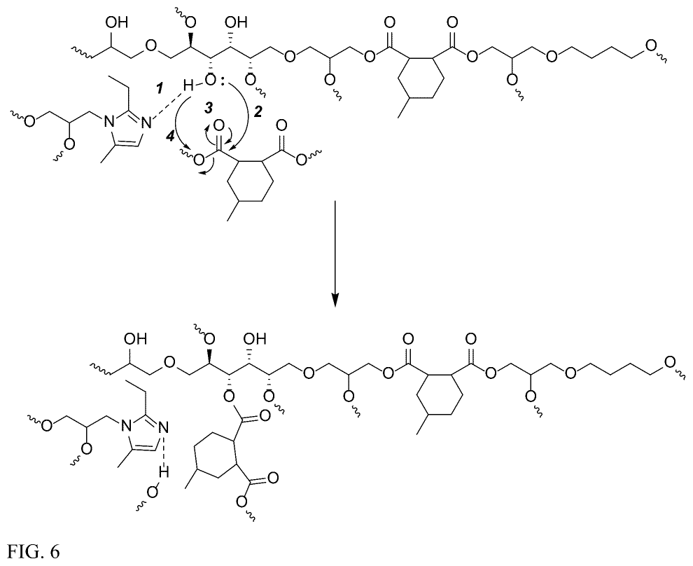

FIG. 6 depicts a proposed mechanism for the nitrogen-mediated internal reaction to the PECAN thermoset with 24EMI. (1) The lone pair of the nitrogen will coordinate to the proton of a sorbitol backbone hydroxide, increasing the electron density of the oxygen. (2) The same oxygen will then bond to the carbon center of the ester, generating a tetrahedral intermediate (not shown) as the electrons from one of the double bonds of the ester shift to the oxygen. (3) Electrons then displace back into the ester double bond while simultaneously displacing the oxygen. (4) At the time of displacement, the oxygen will bond to the coordinated hydrogen completing the reaction (transesterification).

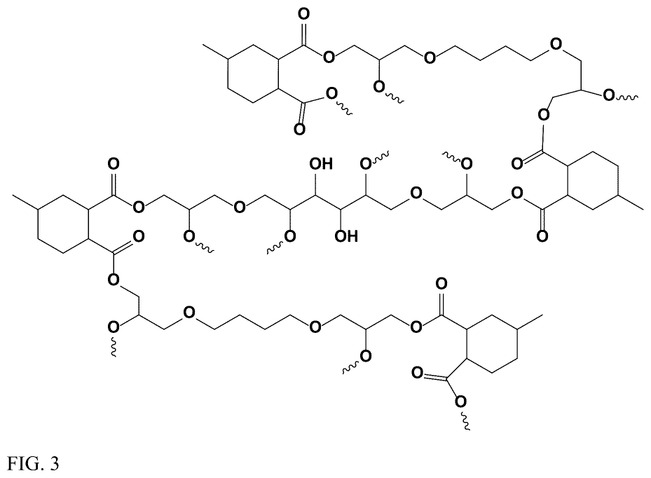

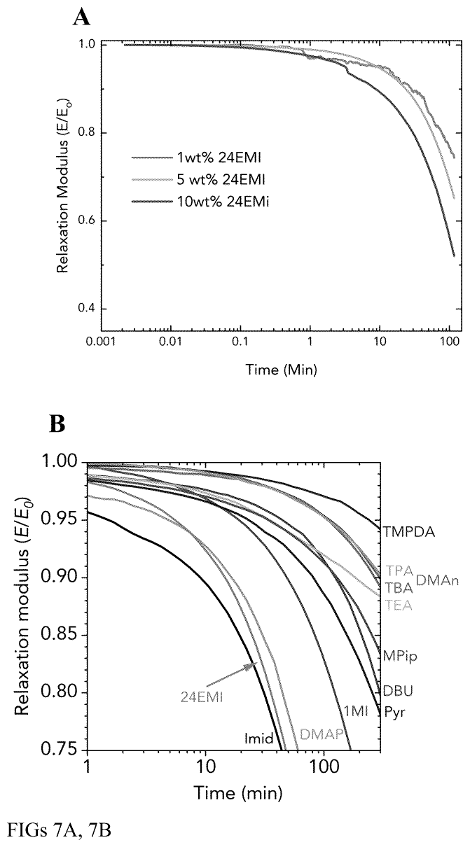

FIGS. 7A and 7B depict stress relaxation experiments. FIG. 7A depicts a PECAN formulation with different concentrations of 24EMI at 200° C. within a Dynamic Mechanical Analyzer (DMA). A stress relaxation experiment will apply a deformation to a sample (1% strain in this case) and monitor the force (converted to modulus) as a function of time. For dynamic networks (such as the PECAN performing transesterification (FIG. 3)), the force will decrease over time resulting in a decrease in the modulus (relaxation modulus in this case) that is then normalized (E/E₀). FIG. 5B depicts similar relaxation experiments (0.25% strain, 200° C.) that were performed for PECAN thermosets cured with alternative catalysts (0.02 mol equivalent) show varying relaxations, dependent on the amine catalyst.

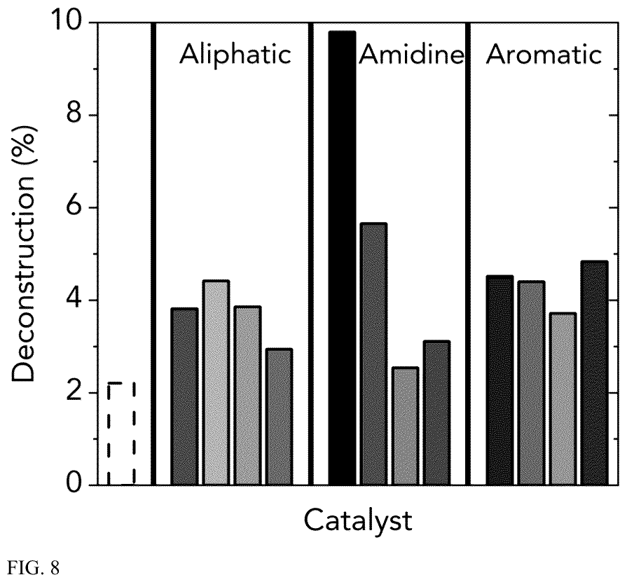

FIG. 8 depicts a comparison to the external transesterification efficacy of PECAN polymers cured with alternative nitrogen-based catalysts and PECAN polymer cured without any catalyst. The percent destruction of the polymers are color coded to catalysts (accelerators) depicted in FIG. 2 including, but not limited to, N-methyl piperidine (Mpip); triethylamine (TEA); imidazole (Imid): 1-methyl imidazole (1 MI): pyridine (Pyr): dimethyl aniline (DMAn): tributylamine (TBA): tripropylamine (TPA): 2-ethyl-4-methyl imidazole (24EMI): 1,8-diazabicyclo[5.4.0]undec-7-ene (DBU): 4-dimethylaminopyridine (DMAP): and N,N,N,N-tetramethyl-1,4-phenylenediamine (TMPDA).

Within these experiments, resin buttons (˜0.5″ in diameter) were subjected to 5 mL methanol/g of PECAN button (˜5 mL) and heated to 130° C. for 36 hours. After 36 hours, the mass loss of the PECAN buttons were compared to the initial mass and quantified as percent deconstruction. Of note, is that all PECAN polymers exhibited higher amounts of deconstruction than that of the uncatalyzed control, validating the efficacy of the nitrogen-based catalyst in this process.

Disclosed herein are methods to create plastics that are net-zero carbon, fully circular, and harmless to the environment. In an embodiment, disclosed herein are plastics that are derived from biobased or waste feedstocks, can be efficiently recycled without diminishing the quality, and can safely breakdown in the soil or ocean if they happen to leak into environment. In an embodiment, disclosed herein are plastics that can be designed at the molecular level to have a range of processability and recyclability in a scalable, low-energy process that minimizes the need for costly material separation and can handle a range of expected contaminates.

In an embodiment, disclosed herein are plastics with ester bonds (also commonly referred to as ester linkages). Most commodity plastics, including polyethylene and polypropylene, are comprised of molecular chains held together by strong carbon-carbon bonds, which makes these materials persistent in the environment and energy-intensive to breakdown using chemical recycling technologies. However, plastics comprised of molecular chains held together by ester linkages, can be more efficiently deconstructed into feedstock materials through known chemical recycling techniques (hydrolysis, methanolysis, enzymatic deconstruction, etc.), and because ester linkages are prevalent in naturally occurring materials, they can offer a pathway for the materials to safely breakdown in the environment.

Existing and emerging plastics with ester linkages include polyethylene terephthalate (PET), polylactic acid (PLA), polybutylene adipate terephthalate (PBAT), polycaprolactone (PCL), and polyhydroxyalkanoates (PHAs). The mechanisms used to break an ester linkage can be the same for all these materials, albeit under different conditions. Ultimately, the ease at which ester linkages in these plastics can be broken, either through a chemical process or degradation in a natural environment, depends on the molecular structure and morphology of each specific material.

In an embodiment, disclosed herein is an energy-efficient chemical processing technology that can breakdown, or deconstruct plastics with ester linkages into valuable feedstock that can be used to make the original plastics that were fed into this process (closed-loop recycling) or new plastics altogether (open-loop recycling). By enabling the deconstruction of a range of different plastics using a single processing technology, the need for excessive sortation of the materials before deconstruction is eliminated. This will also accelerate scaling of the technology because of greater available material volumes, and the technology itself will not be dependent on the commercial success of one single material.

In an embodiment, disclosed herein are methods useful for synthesizing new plastics with ester linkages.

The foregoing disclosure has been set forth merely to illustrate the invention and is not intended to be limiting.

We claim:

1. A method for making thermosetting resin systems comprising the use of at least one type of multi-epoxide (di-epoxide or greater) monomer unit with internal hydroxy functionality comprising sorbitol, and polyglycidyl ether-SPGE.

2. The method of claim 1 further comprising the use of an anhydride hardener and the step of combining the hardener with epoxy and nitrogen-based accelerator to facilitate the cure of the resin into a rigid 3-dimensional network.

3. The method of claim 2 wherien the anhydride hardener comprises methyl hexahydropthalic anhydride (MHHPA).

4. The method of claim 2 wherein the accelerator comprises 2-ethyl-4-methyl imidazole.

5. The method of claim 2 wherein the accelerator comprises N-methyl piperidine triethylamine, imidazole, 1-methyl imidazole, pyridine, dimethyl aniline, tributylamine, tripropylamine, 2-ethyl-4-methyl imidazole, 1,8-diazabicyclo[5.4.0]undec-7-ene, 4-dimethylaminopyridine, and N,N,N,N-tetramethyl-1,4-phenylenediamine.

6. The method of claim 2 wherein the network can rearrange with itself to allow re-processing and with methanol to allow depolymerization.

7. The method of claim 3 wherein the reactions are catalyzed and/or accelerated by a nitrogen-based unit.

8. The method of claim 4 comprising the use of different nitrogen-based accelerators at different loadings to accelerate both cure and transesterification.
